(19) United States
(12) Patent Application Publication
(10) Pub. No.: US 2025/0006964 A1
(43) Pub. Date: Jan. 2, 2025

(54) FUEL CELL SYSTEM AND WORK MACHINE

(71) Applicant: Komatsu Ltd., Tokyo (JP)

(72) Inventor: Tsutomu Ishino, Tokyo (JP)

(73) Assignee: Komatsu Ltd., Tokyo (JP)

(21) Appl. No.: 18/292,967

(22) PCT Filed: Aug. 10, 2022
(86) PCT No.: PCT/JP2022/030650

§ 371 Date: Aug. 22, 2024

(30) Foreign Application Priority Data
Aug. 18, 2021 (JP) 2021-133525

(51) Int. Cl. H01M 8/0662; H01M 8/0606

(52) U.S. Cl. CPC H01M 8/0687; H01M 8/0606; H01M 2250/20

(57) ABSTRACT

A fuel cell system mounted on a work machine includes an outside air introduction member including an outside air introduction port, an air cleaner device that causes air outside the work machine, the air being introduced from the outside air introduction port, to come into contact with liquid, and a fuel cell to which the air after the contact with the liquid and fuel gas are supplied.

### FIELD

The present disclosure relates to a fuel cell system and a working machine.

### BACKGROUND

A fuel cell generates power by chemical reaction between hydrogen as a fuel gas and oxygen as an oxidizing gas. Oxygen in an atmospheric space is often used as the oxidizing gas. In a case where oxygen in the atmospheric space is used as the oxidizing gas, it is necessary to control intrusion of dust in the atmospheric space into the fuel cell. Patent Literature 1 discloses a technique of arranging a wet filter in an oxidant gas supply path of a fuel cell main body.

### CITATION LIST

### Patent Literature

Patent Literature 1: Japanese Patent Application Laid-open No. 2001-185193

### SUMMARY

### Technical Problem

In work sites such as a mine, a construction site, and an agricultural land, a large amount of dust is blown up and floats in an atmospheric space in work of excavating, cutting, cultivating, and transporting soil or rocks. In a case where a fuel cell is mounted on a work machine operating at a work site, there is a demand for a technique capable of controlling intrusion of dust into the fuel cell even when a large amount of dust exists in the atmospheric space.

### Solution to Problem

According to an aspect of the present invention, a fuel cell system mounted on a work machine, the fuel cell system comprises: an outside air introduction member including an outside air introduction port; an air cleaner device that causes air outside the work machine, the air being introduced from the outside air introduction port, to come into contact with liquid; and a fuel cell to which the air after the contact with the liquid and fuel gas are supplied.

### Advantageous Effects of Invention

According to the present disclosure, intrusion of dust in an atmospheric space into a fuel cell is controlled.

### BRIEF DESCRIPTION OF DRAWINGS

FIG. 1 is a view schematically illustrating a work site according to an embodiment.

FIG. 2 is a perspective view illustrating a dump truck according to the embodiment.

FIG. 3 is a view schematically illustrating the dump truck according to the embodiment.

FIG. 4 is a cross-sectional view schematically illustrating an air cleaner device according to the embodiment.

FIG. 5 is a cross-sectional view schematically illustrating the air cleaner device according to the embodiment.

FIG. 6 is a cross-sectional view schematically illustrating a part of a porous member according to the embodiment.

FIG. 7 is a perspective view illustrating an excavator according to the embodiment.

FIG. 8 is a view schematically illustrating the excavator according to the embodiment.

FIG. 9 is a view schematically illustrating the air cleaner device according to the embodiment.

### DESCRIPTION OF EMBODIMENTS

In the following, embodiments according to the present disclosure will be described with reference to the drawings. However, the present disclosure is not limited to the embodiments. Components of the embodiments described in the following can be arbitrarily combined. In addition, there is a case where a part of the components is not used.

### First Embodiment

The first embodiment will be described.

### <Work Site>

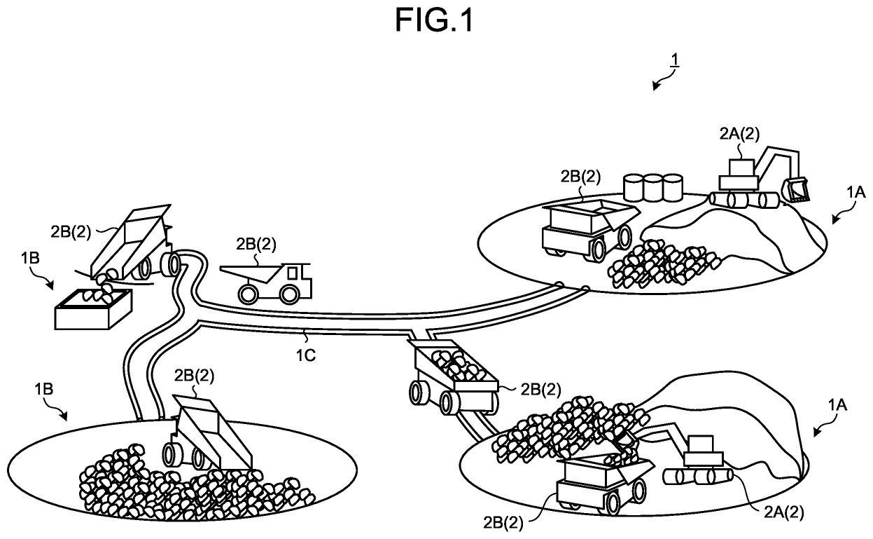

FIG. 1 is a view schematically illustrating a work site 1 according to the embodiment. A plurality of work machines 2 operate at the work site 1. In the embodiment, the work site 1 is a mine. The mine means a business site where minerals are mined. As the work machines 2, an excavator 2A and a dump truck 2B are illustrated as examples.

The work site 1 includes a loading place 1A, a dirt dumping place 1B, and a conveyance path 1C. The loading place 1A means an area where the excavator 2A performs loading work of loading a load onto the dump truck 2B. The dirt dumping place 1B means an area where the dump truck 2B performs dirt dumping work of dumping the load. The conveyance path 1C means a path of the dump truck 2B which path connects the loading place 1A and the dirt dumping place 1B.

### <Dump Truck>

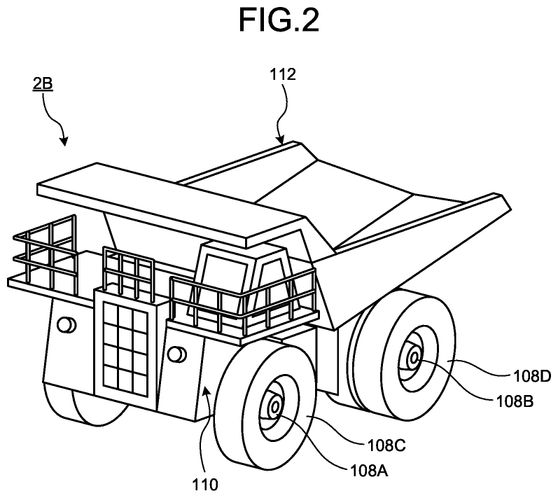

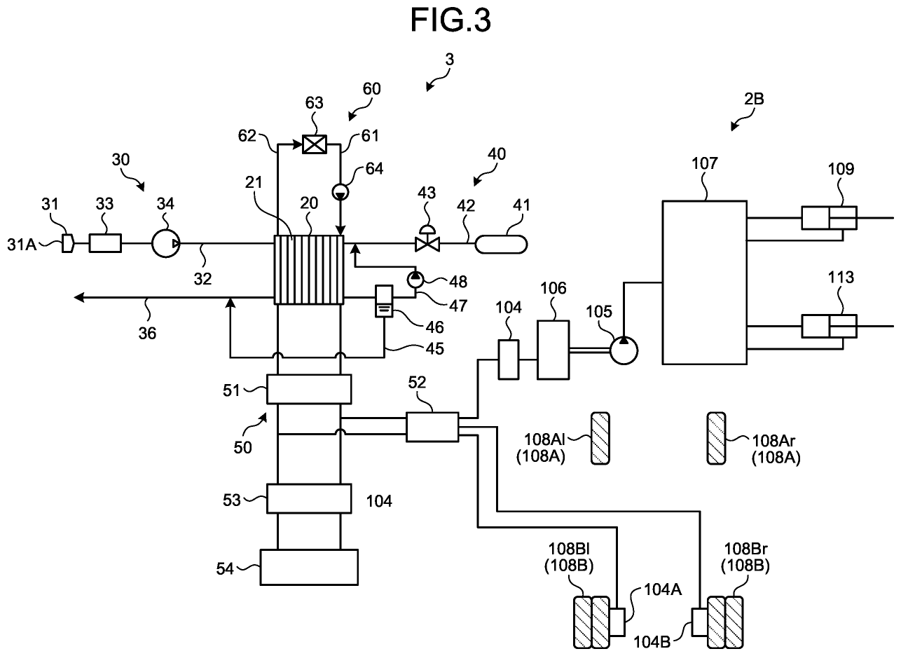

FIG. 2 is a perspective view illustrating the dump truck 2B according to the embodiment. FIG. 3 is a view schematically illustrating the dump truck 2B according to the embodiment. As illustrated in FIG. 2 and FIG. 3, the dump truck 2B includes a fuel cell system 3, an electric motor 104, a power take-off 106, a hydraulic pump 105, a valve device 107, front wheels 108A, rear wheels 108B, a left rear wheel drive motor 104A, a right rear wheel drive motor 104B, a steering cylinder 109, a vehicle body 110, a dump body 112, and a hoist cylinder 113.

Each of the electric motor 104, the left rear wheel drive motor 104A, and the right rear wheel drive motor 104B is driven on the basis of the electric power generated by the fuel cell system 3.

The hydraulic pump 105 is connected to the electric motor 104 via the power take-off 106. The hydraulic pump 105 is driven by the electric motor 104. The hydraulic oil discharged from the hydraulic pump 105 is supplied to each of the steering cylinder 109 and the hoist cylinder 113 via the valve device 107.

Each of the front wheels 108A and the rear wheels 108B supports the vehicle body 110. Front tires 108C are mounted on the front wheels 108A. Rear tires 108D are mounted on the rear wheels 108B. The front wheels 108A include a left front wheel 108Al and a right front wheel 108Ar. The rear wheels 108B include a left rear wheel 108Bl and a right rear wheel 108Br.

The front wheels 108A are steering wheels steered by the steering cylinder 109. The rear wheels 108B are driving wheels rotated by power generated by the left rear wheel drive motor 104A and the right rear wheel drive motor 104B. The left rear wheel 108Bl is connected to the left rear wheel drive motor 104A. The right rear wheel 108Br is connected to the right rear wheel drive motor 104B. The dump truck 2B travels by rotation of the rear tires 108D mounted on the rear wheels 108B.

The steering cylinder 109 is a hydraulic cylinder that is a type of hydraulic actuator. The steering cylinder 109 is driven on the basis of the hydraulic oil ejected from the hydraulic pump 105. The valve device 107 adjusts a direction and flow rate of the hydraulic oil supplied from a hydraulic pump 5 to the steering cylinder 109. The steering cylinder 109 generates power for steering the front wheels 108A.

The vehicle body 110 is supported by each of the front wheels 108A and the rear wheels 108B.

The dump body 112 is a member on which a load is loaded. The dump body 112 is rotated by the hoist cylinder 113. The dump body 112 is a rear dump type. When the dump body 112 is rotated backward by the hoist cylinder 113, the load is discharged from the dump body 112.

The hoist cylinder 113 is a hydraulic cylinder that is a type of hydraulic actuator. The hoist cylinder 113 is driven on the basis of the hydraulic oil ejected from the hydraulic pump 105. The valve device 107 adjusts a direction and a flow rate of the hydraulic oil supplied from the hydraulic pump 5 to the hoist cylinder 113. The hoist cylinder 113 generates power for rotating the dump body 112.

### <Fuel Cell System>

The fuel cell system 3 is mounted on the dump truck 2B. As illustrated in FIG. 3, the fuel cell system 3 includes a fuel cell 20, an oxidizing gas supply device 30, a fuel gas supply device 40, a power regulation device 50, and a refrigerant supply device 60.

The fuel cell 20 generates power by chemical reaction between hydrogen as a fuel gas and oxygen as an oxidizing gas. The fuel cell 20 has a stack structure in which a plurality of unit cells 21 is stacked.

The oxidizing gas supply device 30 supplies air including oxygen to a cathode of the fuel cell 20. The oxidizing gas supply device 30 includes an outside air introduction member 31, an air supply pipe 32, an air cleaner device 33, an air compressor 34, and an exhaust pipe 36.

The outside air introduction member 31 takes in air outside the dump truck 2B. The air outside the dump truck 2B is air in an atmospheric space around the dump truck 2B. The outside air introduction member 31 includes an outside air introduction port 31A that introduces the air in the atmospheric space.

The air supply pipe 32 connects the outside air introduction port 31A of the outside air introduction member 31 and a cathode inlet of the fuel cell 20.

The air cleaner device 33 is arranged in the air supply pipe 32. The air cleaner device 33 removes dust from the air introduced from the outside air introduction port 31A.

The air compressor 34 is arranged between the air cleaner device 33 and the fuel cell 20 in the air supply pipe 32. The air compressor 34 generates suction force at the outside air introduction port 31A. By generation of the suction force in the outside air introduction port 31A, the air outside the dump truck 2B is introduced into the outside air introduction port 31A. After passing through the air cleaner device 33 and the air compressor 34, the air introduced into the outside air introduction port 31A is supplied to the fuel cell 20.

The exhaust pipe 36 connects a cathode outlet of the fuel cell 20 and the atmospheric space around the dump truck 2B.

The fuel gas supply device 40 supplies hydrogen to an anode of the fuel cell 20. The fuel gas supply device 40 includes a hydrogen tank 41, an air supply pipe 42, a pressure regulation valve 43, a drain pipe 45, a gas-liquid separator 46, a circulation pipe 47, and a hydrogen circulation pump 48.

The hydrogen tank 41 stores hydrogen. The hydrogen tank 41 is filled with hydrogen.

The air supply pipe 42 connects the hydrogen tank 41 and an anode inlet of the fuel cell 20.

The pressure regulation valve 43 is arranged in the air supply pipe 42. A pressure of the hydrogen fed from the hydrogen tank 41 is reduced to a prescribed pressure.

The drain pipe 45 connects an anode outlet of the fuel cell 20 and the exhaust pipe 36.

The gas-liquid separator 46 is arranged in the drain pipe 45. The gas-liquid separator 46 separates water from hydrogen discharged from the anode outlet of the fuel cell 20 and stores the water. The water stored in the gas-liquid separator 46 is discharged to the atmospheric space via the drain pipe 45 and the exhaust pipe 36.

Note that the drain pipe 45 may not be connected to the exhaust pipe 36.

The circulation pipe 47 connects the gas-liquid separator 46 and the air supply pipe 42.

The hydrogen circulation pump 48 is arranged in the circulation pipe 47. The hydrogen circulation pump 48 is driven in such a manner as to return, to the fuel cell 20, hydrogen which is discharged from the anode outlet of the fuel cell 20 and from which moisture is removed in the gas-liquid separator 46. Unreacted hydrogen discharged from the fuel cell 20 is reused by the hydrogen circulation pump 48.

The power regulation device 50 supplies power generated by the fuel cell 20 to each of the electric motor 104, the left rear wheel drive motor 104A, and the right rear wheel drive motor 104B. The power regulation device 50 includes a DC-DC converter 51, a motor inverter 52, a DC-DC converter 53, and a storage battery 54.

The DC-DC converter 51 boosts the voltage generated by the fuel cell 20. The DC-DC converter 51 supplies a direct current generated by the fuel cell 20 to the motor inverter 52.

The motor inverter 52 converts the direct current from the DC-DC converter 51 into a three-phase alternating current and supplies the three-phase alternating current to each of the electric motor 104, the left rear wheel drive motor 104A, and the right rear wheel drive motor 104B. Each of the electric motor 104, the left rear wheel drive motor 104A, and the right rear wheel drive motor 104B is driven on the basis of the three-phase alternating current supplied from the motor inverter 52.

The storage battery 54 is charged with the power generated by the fuel cell 20. Similarly to the fuel cell 20, the storage battery 54 functions as a power source of the work machine 2. The DC-DC converter 53 controls charging and discharging of the storage battery 54 in such a manner that the storage battery 54 can supply power to the motor inverter 52 integrally with the fuel cell 20.

Note that the DC-DC converter 53 and the storage battery 54 may be omitted.

The refrigerant supply device 60 supplies a refrigerant to the fuel cell 20 to cool the fuel cell 20. Examples of the refrigerant include water. The refrigerant supply device 60 includes a supply pipe 61, a discharge pipe 62, a radiator 63, and a refrigerant pump 64.

The supply pipe 61 is connected to a refrigerant inlet of the fuel cell 20.

The discharge pipe 62 is connected to a refrigerant outlet of the fuel cell 20.

The radiator 63 is connected to the supply pipe 61 and the discharge pipe 62.

The refrigerant pump 64 is arranged in the supply pipe 61. The refrigerant pump 64 is driven in such a manner that the refrigerant circulates in a circulation path including the supply pipe 61, the fuel cell 20, the discharge pipe 62, and the radiator 63. The radiator 63 exchanges heat between the refrigerant discharged from the fuel cell 20 and the air outside the dump truck 2B and cools the refrigerant.

### <Air Cleaner Device>

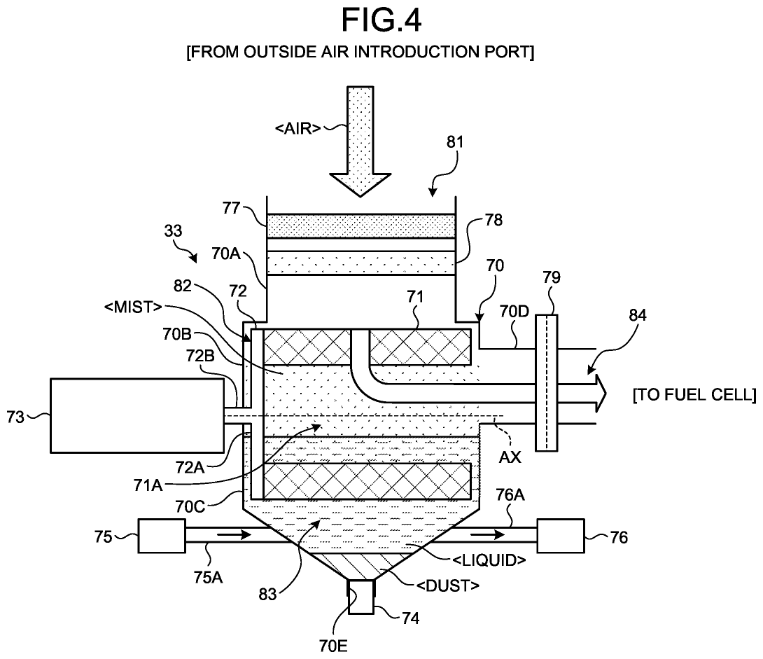

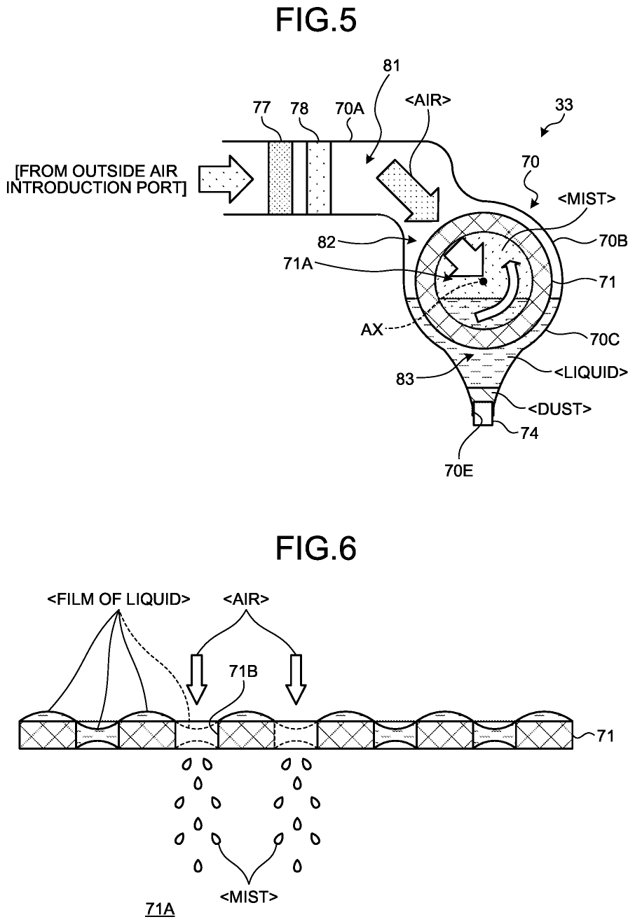

FIG. 4 is a cross-sectional view schematically illustrating the air cleaner device 33 according to the embodiment. FIG. 5 is a cross-sectional view schematically illustrating the air cleaner device 33 according to the embodiment. FIG. 4 is a cross-sectional view of the air cleaner device 33 as viewed from a side. FIG. 5 is a cross-sectional view of the air cleaner device 33 as viewed from a side different from the viewpoint of FIG. 4 by 90 degrees.

The air cleaner device 33 removes dust from the air outside the dump truck 2B which air is introduced from the outside air introduction port 31A. The air cleaner device 33 brings the air outside the dump truck 2B introduced from the outside air introduction port 31A into contact with liquid. When the air and the liquid come into contact with each other, dust included in the air is removed from the air.

The liquid is water in the embodiment. Note that the liquid may include water and an additive added to the water. That is, the liquid may be liquid including water as a main component. Note that the liquid may not be water.

In the work site 1 where the dump truck 2B operates, a large amount of dust floats in the atmospheric space around the dump truck 2B. Specifically, in a mine where minerals are mined, dust including metal as a main component and called metal powder floats in the atmospheric space. For example, in a mine where iron is mined, iron fine particles float as the metal powder in the atmospheric space. In a mine where copper is mined, fine particles of copper float as the metal powder in the atmospheric space.

There is a high possibility that a large amount of dust such as the metal powder is included in the air introduced from the outside air introduction port 31. When the air introduced from the outside air introduction port 31A comes into contact with liquid in the air cleaner device 33, dust included in the air is removed from the air. The air after the contact with the liquid in the air cleaner device 33 is supplied to the fuel cell 20 through the air supply pipe 32. Since the air after the contact with the liquid is supplied to the fuel cell 20, intrusion of the dust in the atmospheric space into the fuel cell 20 is controlled. The air after the contact with the liquid in the air cleaner device 33 and hydrogen from the hydrogen tank 41 are supplied to the fuel cell 20, whereby the fuel cell 20 can appropriately generate power.

As illustrated in FIG. 4 and FIG. 5, the air cleaner device 33 includes a housing 70, a dust filter 77, a chemical filter 78, a porous member 71, a coupling member 72, a cleaner motor 73, a plug 74, a liquid supply device 75, and a liquid recovery device 76.

The housing 70 includes an air inflow portion 70A, a support portion 70B, a storage portion 70C, and an air outflow portion 70D. In the embodiment, the air inflow portion 70A, the support portion 70B, the storage portion 70C, and the air outflow portion 70D are a single member. In the embodiment, the air inflow portion 70A, the support portion 70B, the storage portion 70C, and the air outflow portion 70D may be separate members.

The air inflow portion 70A forms an inflow passage 81 through which the air outside the dump truck 2B introduced from the outside air introduction port 31A flows. The air inflow portion 70A is connected to the outside air introduction member 31 via at least a part of the air supply pipe 32. As illustrated in FIG. 5, in the embodiment, the dust filter 77 and the chemical filter 78 are arranged in the inflow passage 81. The dust filter 77 is a paper filter that collects the dust included in the air introduced from the outside air introduction port 31A. The dust filter 77 collects dust having a large particle size. The chemical filter 78 is a paper filter into which a material that collects chemical substances included in the air introduced from the outside air introduction port 31A is kneaded. Examples of chemical substances that can be collected by the chemical filter 78 include sulfur, nitrogen, and a chlorine compound.

The support portion 70B is connected to a lower portion of the air inflow portion 70A. The support portion 70B forms a treatment space 82 in which at least a part of the porous member 71 is arranged. The support portion 70B supports the porous member 71. The treatment space 82 is connected to the inflow passage 81. The inflow passage 81 is connected to an upper end of the treatment space 82. The air flowing through the inflow passage 81 flows into the treatment space 82.

The storage portion 70C is connected to a lower portion of the support portion 70B. The storage portion 70C forms a storage space 83 in which liquid is stored. The storage space 83 is connected to the treatment space 82. The treatment space 82 is arranged above the storage space 83. The treatment space 82 and the storage space 83 are integrated. At least a part of the porous member 71 is arranged in the storage space 83.

The air outflow portion 70D is connected to a side portion of the support portion 70B. The air outflow portion 70D forms an outflow passage 84 through which air from the treatment space 82 flows. The treatment space 82 is connected to the outflow passage 84. The outflow passage 84 is connected to a side portion of the treatment space 82. The air outflow portion 70D is connected to the fuel cell 20 via at least a part of the air supply pipe 32. The air flowing through the treatment space 82 flows into the outflow passage 84. The air flowing through the outflow passage 84 is supplied to the fuel cell 20 via the air compressor 34. As illustrated in in FIG. 4, in the embodiment, an eliminator 79 is arranged in the outflow passage 84. The eliminator 79 blocks mist of liquid included in the air from entering the fuel cell 20.

The porous member 71 has a plurality of holes. In the embodiment, the porous member 71 includes a mesh plate. The air can pass through the holes of the porous member 71. The liquid can also pass through the holes of the porous member 71. The porous member 71 can hold the liquid.

In the embodiment, the porous member 71 has a cylindrical shape. The porous member 71 is formed by bending of the mesh plate.

Note that the porous member 71 may have a network structure in which a plurality of fibers or bar-shaped members are knitted.

The coupling member 72 is fixed to the porous member 71. The coupling member 72 includes a disk portion 72A connected to an end on one side in an axial direction of the porous member 71, and a shaft portion 72B protruding from the disk portion 72A. The disk portion 72A is fixed to the end on the one side in the axial direction of the porous member 71 in such a manner as to close an opening of the porous member 71 provided on the one side in the axial direction of the porous member 71. The shaft portion 72B protrudes from a center of the disk portion 72A to the one side in the axial direction of the porous member 71.

The support portion 70B supports the porous member 71 via the coupling member 72. In the embodiment, the support portion 70B supports the shaft portion 72B of the coupling member 72. The support portion 70B supports the porous member 71 in such a manner that a central axis AX of the porous member 71 and a vertical axis are orthogonal to each other. That is, the support portion 70B supports the porous member 71 in such a manner that the central axis AX of the porous member 71 extends in a lateral direction.

The support portion 70B rotatably supports the porous member 71. The support portion 70B supports the porous member 71 in such a manner that the porous member 71 rotates about the central axis AX. The support portion 70B has an opening in which the shaft portion 72B is arranged. The shaft portion 72B is supported by a bearing (not illustrated) arranged in the opening of the support portion 70B.

The cleaner motor 73 is an electric motor. The cleaner motor 73 is connected to the shaft portion 72B of the coupling member 72. The cleaner motor 73 generates power to rotate the porous member 71 about the central axis AX.

The plug 74 is arranged in an opening 70E provided at a bottom of the storage portion 70C. The plug 74 is attached to and detached from the opening 70E.

The liquid supply device 75 supplies liquid to the storage space 83. The liquid supply device 75 is connected to the storage space 83 via a supply pipe 75A. The liquid supply device 75 supplies the liquid to the storage space 83 via the supply pipe 75A.

The liquid recovery device 76 recovers the liquid from the storage space 83. The liquid recovery device 76 is connected to the storage space 83 via a recovery pipe 76A. The liquid recovery device 76 recovers the liquid from the storage space 83 by sucking the liquid in the storage space 83 through the recovery pipe 76A.

### Operation

Next, an operation of the fuel cell system 3 will be described. When the air compressor 34 is started, the air outside the dump truck 2B is introduced into the outside air introduction port 31A. The air introduced into the outside air introduction port 31A flows into the treatment space 82 via the inflow passage 81. In addition, the liquid is stored in the storage space 83.

As illustrated in FIG. 4 and FIG. 5, a lower portion of the porous member 71 below the central axis AX is arranged in the storage space 83. That is, the lower portion of the porous member 71 is immersed in the liquid in the storage space 83. An upper portion of the porous member 71 above the central axis AX is arranged in the treatment space 82. That is, the upper portion of the porous member 71 is not immersed in the liquid in the storage space 83 and is outside the liquid in the storage space 83.

The support portion 70B rotatably supports the porous member 71 in such a manner that at least a part of the porous member 71 is changed between a first state of being immersed in the liquid in the storage space 83 and a second state of being outside the liquid in the storage space 83. The cleaner motor 73 keeps rotating the porous member 71 at a prescribed rotation speed at least during a period in which the air flows into the treatment space 82 from the outside air introduction port 31A.

The cleaner motor 73 rotates the porous member 71 in such a manner that at least the part of the porous member 71 is changed between the first state and the second state. In a case where a part of the porous member 71 is focused on, by the rotation of the porous member 71, the part of the porous member 71 repeats the first state of being immersed in the liquid in the storage space 83 and the second state of being outside the liquid in the storage space 83.

The part of the porous member 71 which part is immersed in the liquid in the storage space 83 is wet with the liquid. The part of the porous member 71 which part is changed from the first state to the second state is arranged in the treatment space 82 in a state of being wet with the liquid.

The air outside the dump truck 2B which air flows through the inflow passage 81 of the air inflow portion 70A is supplied to at least the part of the porous member 71 which part is changed from the first state to the second state and arranged in the treatment space 82. That is, the air introduced from the outside air introduction port 31A and flowing through the inflow passage 81 is supplied to the part of the porous member 71 which part is arranged in the treatment space 82 in the wet state.

As described above, the porous member 71 has the cylindrical shape in the embodiment. The air from the inflow passage 81 is supplied to an outer surface of the porous member 71 in the second state from an upper side. The air supplied to the outer surface of the porous member 71 and passing through the holes of the porous member 71 flows into an inner space 71A of the porous member 71, and then flows out from an end on the other side in the axial direction of the inner space 71A. The air flowing out from the end on the other side in the axial direction of the inner space 71A flows through the outflow passage 84, and then is supplied to the fuel cell 20.

FIG. 6 is a cross-sectional view schematically illustrating a part of the porous member 71 according to the embodiment. As illustrated in FIG. 6, in the porous member 71 changed from the first state to the second state, a film of the liquid is formed on a surface of the porous member 71. Furthermore, the film of the liquid is also formed in a holes 71B of the porous member 71. The air supplied from the inflow passage 81 to the porous member 71 comes into contact with the film of the liquid formed on the porous member 71. When the air comes into contact with the film of the liquid formed on the porous member 71, the dust included in the air is caught by the liquid. The dust is held in the porous member 71 or the liquid wetting the porous member 71.

In addition, when the air hits the film of the liquid formed in the holes 71B, mist of the liquid is generated. In the embodiment, the mist of the liquid is generated exclusively in the inner space 71A of the porous member 71. In addition, the rotation of the porous member 71 that is wet with the liquid also generates the mist of the liquid in the inner space 71A of the porous member 71. The inner space 71A of the porous member 71 becomes a mist space in which the generated mist exists.

At least a part of the air that passes through the holes 71B passes through the inner space 71A that is the mist space. As the air passes through the mist space, the dust included in the air is caught by the liquid. The dust falls into the storage space 83 together with the mist. The liquid in the storage space 83 catches the dust included in the mist. The liquid in the storage space 83 collects the fallen dust.

When changing from the second state to the first state due to the rotation of the porous member 71, the part of the porous member 71 which part holds the dust in the treatment space 82 is immersed in the liquid in the storage space 83. The dust held by the part of the porous member 71 is caught by the liquid in the storage space 83. The part of the porous member 71 immersed in the liquid in the storage space 83 is cleaned with the liquid in the storage space 83. The liquid in the storage space 83 collects the dust from the part of the porous member 71 which part is changed from the second state to the first state.

As illustrated in FIG. 4 and FIG. 5, the dust collected in the liquid in the storage space 83 is deposited at the bottom of the storage space 83. When the plug 74 is detached from the opening 70E, the dust deposited at the bottom of the storage space 83 is discharged from the storage space 83 through the opening 70E.

In the embodiment, the liquid recovery device 76 performs liquid recovery operation in parallel with liquid supply operation by the liquid supply device 75. The liquid supply operation by the liquid supply device 75 and the liquid recovery operation by the liquid recovery device 76 are continued at least during the period in which the air flows into the treatment space 82 from the outside air introduction port 31A. As a result, a certain amount of clean liquid is kept stored in the storage space 83.

### Effect

As described above, according to the embodiment, the fuel cell system 3 includes the air cleaner device 33 that brings the air in the atmospheric space introduced from the outside air introduction port 31A into contact with the liquid. When the air introduced from the outside air introduction port 31A comes into contact with the liquid in the air cleaner device 33, the dust included in the air is removed from the air. Since the air after the contact with the liquid is supplied to the fuel cell 20, the dust in the atmospheric space is prevented from intruding into the fuel cell 20.

For example, it is difficult to collect minute dust such as the metal powder with the dust filter 77. In addition, when meshes of the dust filter 77 are made finer to collect the minute dust, intake resistance becomes too large to suck as much air as desired. Thus, the meshes of the dust filter 77 cannot be made equal to or smaller than a certain degree. When it is made possible to suck the air, the metal powder enters the fuel cell 20 as a result thereof. According to the embodiment, since the air cleaner device 33 catches the dust with the liquid, even when a large amount of dust floats in the atmospheric space as in the work site 1 in the mine, the dust can be smoothly and efficiently removed from the air.

The air cleaner device 33 includes the porous member 71 that is wet with the liquid. As the air passes through the holes 71B of the porous member 71 that is wet with the liquid, the dust included in the air is caught by the liquid held by the porous member 71.

The film of the liquid is formed in the holes 71B of the porous member 71. When the air hits the film of the liquid, the mist of the liquid is generated in the inner space 71A. At least a part of the air passing through the holes 71B passes through the inner space 71A that is the mist space in which the generated mist exists. The dust included in the air is caught by at least one of the film of the liquid or the mist of the liquid.

The air cleaner device 33 includes the storage portion 70C that forms the storage space 83 in which the liquid is stored, the support portion 70B that supports the porous member 71 in such a manner that at least the part of the porous member 71 is changed between the first state of being immersed in the liquid in the storage space 83 and the second state of being outside the liquid in the storage space 83, and the air inflow portion 70A that forms the inflow passage 81 through which the air in the atmospheric space which air is supplied to at least the part of the porous member 71 which part is changed from the first state to the second state flows. As a result, the air in the atmospheric space can be supplied to the porous member 71 that is wet with the liquid.

The porous member 71 has a cylindrical shape. The support portion 70B rotatably supports the porous member 71 in such a manner that at least the part of the porous member 71 is changed between the first state and the second state. Thus, in a case where the part of the porous member 71 is focused on, the part of the porous member 71 can repeat the first state and the second state. The part of the porous member 71 in the first state can catch the dust included in the air. The part of the porous member 71 in the second state is cleaned by the liquid in the storage space 83.

The air cleaner device 33 includes the cleaner motor 73 that rotates the porous member 71 in such a manner that at least the part of the porous member 71 is changed between the first state and the second state. The part of the porous member 71 can repeat the first state and the second state by the power generated by the cleaner motor 73.

The air from the inflow passage 81 is supplied to the outer surface of the porous member 71 in the second state. The air passing through the holes 71B of the porous member 71 flows into the inner space 71A of the porous member 71, and then flows out from the end in the axial direction of the inner space 71A. As a result, the air after the contact with the liquid is supplied to the fuel cell 20.

The mist of the liquid is generated by the rotation of the porous member 71. The inner space 71A of the porous member 71 includes the mist space in which the generated mist exists. When the air passes through the inner space 71A, the dust included in the air is caught by the mist of the liquid.

The part of the porous member 71 which part is changed from the second state to the first state is cleaned with the liquid in the storage space 83. The liquid in the storage space 83 can collect the dust from at least the part of the porous member 71 which part is changed from the second state to the first state.

The opening 70E is provided at the bottom of the storage portion 70C. The air cleaner device 33 includes the plug 74 arranged in the opening 70E. When the plug 74 is detached from the opening 70E, the dust deposited at the bottom of the storage space 83 is discharged from the storage space 83 through the opening 70E.

The air cleaner device 33 includes the liquid supply device 75 that supplies the liquid to the storage space 83, and the liquid recovery device 76 that recovers the liquid from the storage space 83. As a result, the clean liquid is stored in the storage space 83.

### Modification Example

The cleaner motor 73 may be omitted in the above-described embodiment. The porous member 71 rotatably supported by the support portion 70B may be rotated by force of the air supplied from the inflow passage 81. The porous member 71 rotatably supported by the support portion 70B may be rotated by force of the liquid supplied from the liquid supply device 75. A porous member 71 may be provided with a fin. When air or liquid hits the fin, the porous member 71 can rotate smoothly.

In the above-described embodiment, water generated in the fuel cell 20 may be used as the liquid in the storage space 83. That is, the water separated from hydrogen in the gas-liquid separator 46 may be supplied to the storage space 83. As a result, the water generated in the fuel cell 20 is effectively used.

In the above-described embodiment, the liquid supply device 75 and the liquid recovery device 76 may be omitted. The liquid in the storage space 83 may be periodically replaced.

In the above-described embodiment, a pre-cleaner may be arranged between the outside air introduction port 31A and the dust filter 77.

In the above-described embodiment, a dust filter that catches dust by magnetic force may be arranged or a dust filter that catches dust by electrostatic force may be arranged in the inflow passage 81.

### Second Embodiment

The second embodiment will be described. In the following description, the same sign is assigned to a component identical or equivalent to that of the above-described embodiment, and a description of the component is simplified or omitted.

It is assumed in the above-described embodiment that the fuel cell system 3 is mounted on the dump truck 2B. A fuel cell system 3 may be mounted on an excavator 2A.

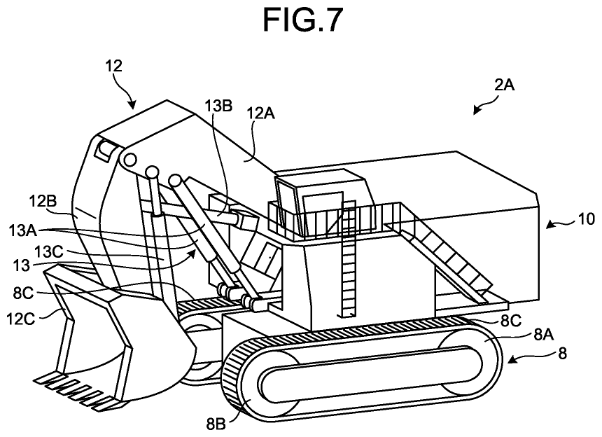

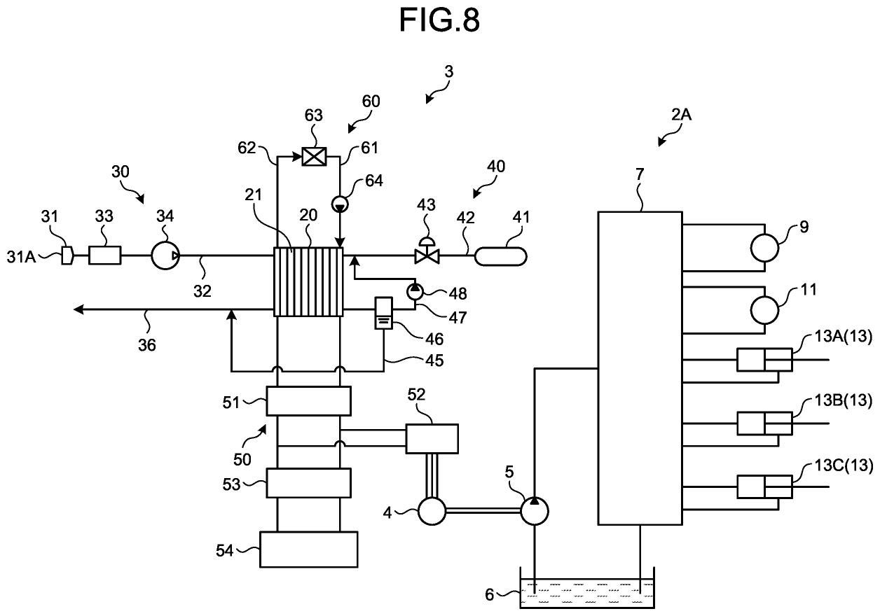

FIG. 7 is a perspective view illustrating the excavator 2A according to the embodiment. FIG. 8 is a view schematically illustrating the excavator 2A according to the embodiment. As illustrated in FIG. 7 and FIG. 8, the excavator 2A includes a fuel cell system 3, an electric motor 4, a hydraulic pump 5, a valve device 7, a traveling body 8, a traveling motor 9, a swing body 10, a swing motor 11, working equipment 12, and a working equipment cylinder 13.

The fuel cell system 3 includes the air cleaner device 33 described in the above-described embodiment. The electric motor 4 is driven on the basis of power generated by the fuel cell system 3.

The hydraulic pump 5 is driven by the electric motor 4. Hydraulic oil discharged from the hydraulic pump 5 is supplied to each of the traveling motor 9, the swing motor 11, and the working equipment cylinder 13 via the valve device 7.

The traveling body 8 travels in a state of supporting the swing body 10. The traveling body 8 includes a driving wheel 8A, a driven wheel 8B, and a crawler belt 8C supported by the driving wheel 8A and the driven wheel 8B.

The traveling motor 9 is a hydraulic motor that is a type of hydraulic actuator. The traveling motor 9 is driven on the basis of the hydraulic oil discharged from the hydraulic pump 5. The traveling motor 9 generates power to rotate the driving wheel 8A.

The swing body 10 is a vehicle body of the excavator 2A. The swing body 10 swings in a state of being supported by the traveling body 8.

The swing motor 11 is a hydraulic motor that is a type of hydraulic actuator. The swing motor 11 is driven on the basis of the hydraulic oil discharged from the hydraulic pump 5. The swing motor 11 generates power to swing the swing body 10.

The working equipment 12 is mounted on the swing body 10. The working equipment 12 includes a boom 12A, an arm 12B, and a bucket 12C.

The working equipment cylinder 13 is a hydraulic cylinder that is a type of hydraulic actuator. The working equipment cylinder 13 is driven on the basis of the hydraulic oil discharged from the hydraulic pump 5. The working equipment cylinder 13 generates power to operate the working equipment 12. The working equipment cylinder 13 includes a boom cylinder 13A, an arm cylinder 13B, and a bucket cylinder 13C.

As described above, the fuel cell system 3 may be mounted on the excavator 2A. The fuel cell system 3 includes the air cleaner device 33 described in the above-described embodiment. Thus, dust in an atmospheric space is prevented from intruding into a fuel cell 20.

### Third Embodiment

The third embodiment will be described. In the following description, the same sign is assigned to a component identical or equivalent to that of the above-described embodiment, and a description of the component is simplified or omitted.

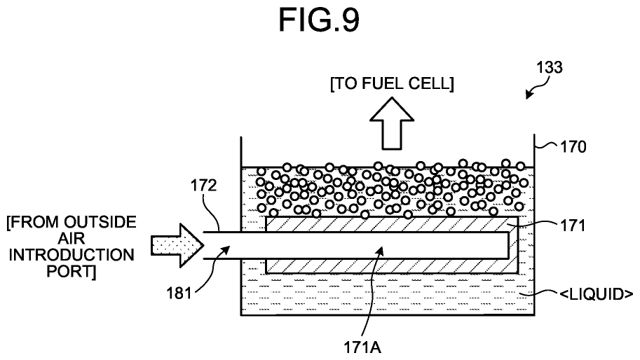

FIG. 9 is a view schematically illustrating an air cleaner device 133 according to the embodiment. As illustrated in FIG. 9, the air cleaner device 133 includes a case 170, a porous member 171, and an air inflow pipe 172.

The case 170 stores liquid. The liquid is stored in the case 170.

The porous member 171 is immersed in the liquid in the case 170. The porous member 171 has a cylindrical shape. The porous member 171 has a plurality of holes. Air can pass through the holes of the porous member 171. Dust can also pass through the holes of the porous member 171. Liquid can also pass through the holes of the porous member 71.

The air inflow pipe 172 forms an inflow passage 181 through which air outside a work machine 2 which air is introduced from an outside air introduction port (not illustrated) flows. The air flowing through the inflow passage 181 is supplied to an inner space 171A of the porous member 171.

The air outside the work machine 2 which air is introduced from the outside air introduction port flows through the inflow passage 181 and then is supplied to the inner space 171A of the porous member 171. The air supplied to the inner space 171A passes through the holes of the porous member 171. The air that passes through the holes of the porous member 171 forms bubbles and is ejected to liquid around the porous member 171. The air passing through the holes of the porous member 171 comes into contact with the liquid around the porous member 171. In a case where dust is included in the air, the dust is captured by the liquid. The liquid stored in the case 170 collects the dust. The dust is deposited at the bottom of the case 170.

As described above, the air cleaner device 133 also prevents dust in an atmospheric space from intruding into a fuel cell 20.

### REFERENCE SIGNS LIST

1 WORK SITE
1A LOADING PLACE
1B DIRT DUMPING PLACE
1C CONVEYANCE PATH
2 WORK MACHINE
2A EXCAVATOR
2B DUMP TRUCK
3 FUEL CELL SYSTEM
4 ELECTRIC MOTOR
5 HYDRAULIC PUMP
7 VALVE DEVICE
8 TRAVELING BODY
8A DRIVING WHEEL
8B DRIVEN WHEEL
8C CRAWLER BELT
9 TRAVELING MOTOR
10 SWING BODY
11 SWING MOTOR
12 WORKING EQUIPMENT
12A BOOM
12B ARM
12C BUCKET
13 WORKING EQUIPMENT CYLINDER
13A BOOM CYLINDER
13B ARM CYLINDER
13C BUCKET CYLINDER
20 FUEL CELL
21 UNIT CELL
30 OXIDIZING GAS SUPPLY DEVICE
31 OUTSIDE AIR INTRODUCTION MEMBER
31A OUTSIDE AIR INTRODUCTION PORT
32 AIR SUPPLY PIPE
33 AIR CLEANER DEVICE
34 AIR COMPRESSOR
36 EXHAUST PIPE
40 FUEL GAS SUPPLY DEVICE
41 HYDROGEN TANK
42 AIR SUPPLY PIPE
43 PRESSURE REGULATION VALVE
45 DRAIN PIPE
46 GAS-LIQUID SEPARATOR
47 CIRCULATION PIPE
48 HYDROGEN CIRCULATION PUMP
50 POWER REGULATION DEVICE
51 DC-DC CONVERTER
52 MOTOR INVERTER
53 DC-DC CONVERTER
54 STORAGE BATTERY
60 REFRIGERANT SUPPLY DEVICE
61 SUPPLY PIPE
62 DISCHARGE PIPE
63 RADIATOR
64 REFRIGERANT PUMP
70 HOUSING
70A AIR INFLOW PORTION
70B SUPPORT PORTION
70C STORAGE PORTION
70D AIR OUTFLOW PORTION
70E OPENING
71 POROUS MEMBER
71A INNER SPACE
71B HOLE
72 COUPLING MEMBER
72A DISK PORTION
72B SHAFT PORTION
73 CLEANER MOTOR
74 PLUG
75 LIQUID SUPPLY DEVICE
75A SUPPLY PIPE
76 LIQUID RECOVERY DEVICE
76A RECOVERY PIPE
77 DUST FILTER
78 CHEMICAL FILTER
79 ELIMINATOR
81 INFLOW PASSAGE
82 TREATMENT SPACE
83 STORAGE SPACE
84 OUTFLOW PASSAGE
104 ELECTRIC MOTOR
104A LEFT REAR WHEEL DRIVE MOTOR
104B RIGHT REAR WHEEL DRIVE MOTOR
105 HYDRAULIC PUMP
106 POWER TAKE-OFF
107 VALVE DEVICE
108A FRONT WHEEL
108B REAR WHEEL
108C FRONT TIRE
108D REAR TIRE
109 STEERING CYLINDER
110 VEHICLE BODY
112 DUMP BODY
113 HOIST CYLINDER
133 AIR CLEANER DEVICE
170 CASE
171 POROUS MEMBER
171A INNER SPACE
172 AIR INFLOW PIPE
181 INFLOW PASSAGE
AX CENTRAL AXIS

1. A fuel cell system mounted on a work machine, the fuel cell system comprising:
an outside air introduction member including an outside air introduction port;
an air cleaner device that causes air outside the work machine, the air being introduced from the outside air introduction port, to come into contact with liquid; and
a fuel cell to which the air after the contact with the liquid and fuel gas are supplied.

2. The fuel cell system according to claim 1, wherein
the air cleaner device includes a porous member that is wet with the liquid, and
air passing through holes of the porous member is supplied to the fuel cell.

3. The fuel cell system according to claim 2, wherein
a film of the liquid is formed in the holes of the porous member, and
mist of the liquid is generated when the outside air hits the film of the liquid, and
at least a part of the air passing through the holes passes through a mist space in which the generated mist exists.

4. The fuel cell system according to claim 2, wherein
the air cleaner device includes
a storage portion that forms a storage space in which the liquid is stored,
a support portion that supports the porous member in such a manner that at least a part of the porous member is changed between a first state of being immersed in the liquid in the storage space and a second state of being outside the liquid in the storage space, and
an air inflow portion that forms an inflow passage through which the outside air supplied to at least the part of the porous member changed from the first state to the second state flows.

5. The fuel cell system according to claim 4, wherein
the porous member has a cylindrical shape, and
the support portion rotatably supports the porous member in such a manner that at least the part of the porous member is changed between the first state and the second state.

6. The fuel cell system according to claim 5, wherein
the air cleaner device includes
a cleaner motor that rotates the porous member in such a manner that at least the part of the porous member is changed between the first state and the second state.

7. The fuel cell system according to claim 5 or claim 6, wherein
the air from the inflow passage is supplied to an outer surface of the porous member in the second state, and
the air passing through the holes of the porous member flows into an inner space of the porous member and then flows out from an end in an axial direction of the inner space.

8. The fuel cell system according to claim 7, wherein
mist of the liquid is generated by rotation of the porous member, and
the inner space includes a mist space in which the generated mist exists.

9. The fuel cell system according to any one of claim 4 to claim 8, wherein
the liquid in the storage space collects dust from at least the part of the porous member which part is changed from the second state to the first state.

10. The fuel cell system according to claim 9, wherein
the dust includes metal powder.

11. The fuel cell system according to claim 9 or claim 10, wherein
an opening is provided at a bottom of the storage portion, and
the air cleaner device includes a plug arranged in the opening.

12. The fuel cell system according to any one of claim 4 to claim 11, wherein
the air cleaner device includes
a liquid supply device that supplies the liquid to the storage space, and
a liquid recovery device that recovers the liquid from the storage space.

13. The fuel cell system according to any one of claim 4 to claim 12, wherein
the liquid in the storage space includes water generated in the fuel cell.

14. A work machine comprising:
the fuel cell system according to any one of claim 1 to claim 13;
an electric motor that is driven on a basis of power generated by the fuel cell;
a hydraulic pump driven by the electric motor; and
a hydraulic actuator that is driven on a basis of hydraulic oil discharged from the hydraulic pump.

15. The work machine according to claim 14, further comprising:
a vehicle body; and
a working equipment mounted on the vehicle body, wherein
the hydraulic actuator includes a hydraulic cylinder that operates the working equipment.

16. The work machine according to claim 14, further comprising:
a vehicle body; and
a dump body supported by the vehicle body, wherein
the hydraulic actuator includes a hydraulic cylinder that rotates the dump body.
